(19) United States
(12) Patent Application Publication
(10) Pub. No.: US 2015/0290666 A1
(43) Pub. Date: Oct. 15, 2015

(54) PLANNED OBSOLESCENCE CARTRIDGE, FOR PRODUCING AND DISPENSING AN AEROSOL, AND SPRAYING APPARATUS COMPRISING SAME

(71) Applicant: Karim BENALIKHOUDJA, (US)

(72) Inventor: Karim BENALIKHOUDJA, Serres Sainte Marie (FR)

(21) Appl. No.: 14/440,735

(22) PCT Filed: Nov. 8, 2013
(86) PCT No.: PCT/FR2013/052697

§ 371 Date: May 5, 2015

(30) Foreign Application Priority Data
Nov. 8, 2012 (FR) 1260595

(51) Int. Cl. B05B 12/08; B05B 7/24

(52) U.S. Cl. CPC B05B 12/081; B05B 7/2491

(57) ABSTRACT

The cartridge (1) for dispensing an aerosol includes a liquid container (12), a nozzle (5) communicating with the container via a suction cannula (4) and a compressor (6) for producing a carrier stream of compressed air introduced into the nozzle such that the contents of the container are first sucked in, then fractionated and finally propelled into an expansion chamber (13) and then to the outside. The cartridge is remarkable in that the elements of which it consists form a non-dismountable assembly and includes electronic circuitry (9) of planned obsolescence capable of directly or indirectly determining the total quantity of liquid consumed during previous operation cycles, of comparing this value with a setpoint value representative of the quantity of liquid present in the container before the first use, and of preventing the subsequent operation of the compressor when the liquid contained in the container has been drained.

### TECHNICAL FIELD

The present invention is in the field of devices used for forming and dispensing a liquid substance in micro-droplet form into the atmosphere of a residential or commercial site and more specifically concerns a cartridge for producing and dispensing an aerosol and an apparatus comprising same, the aerosol being able to be formed from a perfume in liquid form, an animal repellent in liquid form, a disinfectant in liquid form for bacteriological decontamination of air and surfaces of sites, curative substances in liquid form for therapeutic purposes, for example for treating the airways of patients using aerosol therapy, or else for veterinary purposes, for example for the vaccination of animals on a farm. The aerosol can be formed from a liquid fuel and a combustive gas for the purposes of powering heat engines with an energy source inside the cylinders.

### PRIOR ART

Various apparatuses for spraying a liquid substance of the aforementioned type are known to the prior art. Typically, these apparatuses comprise a container intended to contain the liquid substance to be sprayed, a spraying nozzle in communication with the container, capable of fractionating the perfumed substance into fine droplets and dispensing it in this form into the atmosphere, and an air compressor actuated by an electric motor capable of producing a vector stream introduced into the spraying nozzle so that the substance to be sprayed is first sucked toward the nozzle by Venturi effect, then fractionated in the latter and finally propelled to the outside by the carrier stream.

An apparatus of this type is known, particularly from the patent FR 2 947 191 by the Applicant.

### DISCLOSURE OF THE INVENTION

### Technical Problem

For most apparatuses of the prior art, the container is removable and once empty can be easily replaced and refilled. The drawback of such an arrangement is that the container can be recharged with liquid products incompatible with, in particular, the features of the nozzle, which can be fouled or even severely damaged if the liquid product is corrosive to the material of which it is composed. Furthermore, the container can, by error or malicious intent, be recharged with liquid products incompatible with the normal use of the apparatus, or even with products that are toxic to the occupants of the site or the residence in which these products are to be dispensed.

### Technical Solution

The aim of the present invention is to palliate the previously described drawbacks by removing any risk of error in the spraying and dispensing of a substance unsuitable for the envisioned use and by preventing any subsequent use after the liquid has been drained.

Another aim of the present invention is a cartridge that is cheap to manufacture and recyclable after use.

For this purpose, the subject of the present invention is a spraying cartridge comprising a container containing a liquid to be sprayed, a two-phase spraying nozzle in communication with the container by at least one suction cannula and an air compressor capable of producing a carrier stream of compressed air introduced into the spraying nozzle so that the contents of the container is first sucked in by Venturi effect, then fractionated and finally propelled first to an expansion chamber and then to the outside, still by the carrier stream, essentially characterized in that the elements of which it consists form a non-dismountable assembly and in that it includes means of planned obsolescence capable of directly or indirectly determining the total quantity of liquid consumed in previous operating cycles, of comparing this value to a setpoint value representative of the quantity of liquid present in the container before the first use, and capable of preventing the subsequent operation of the compressor when the liquid contained in the container has been drained.

Such an arrangement renders the cartridge unusable even if its container is filled again. In this way any risk of dispensation of substances unsuitable for the envisioned use and particularly of toxic substances or other unwanted substances is removed.

In another feature of the invention, the air compressor is equipped with an electrical actuator motor and said compressor with its motor are arranged in the cartridge.

Such an arrangement confers features of compactness and operational autonomy upon the cartridge.

In another feature of the invention, the cartridge is formed from an enclosure, wherein the lower part of its inner volume forms a liquid container and wherein the upper part of its inner volume receives the air compressor and its motor as well as the two-phase nozzle, said enclosure receiving a partition wall in the shape of a funnel ensuring a separation between the upper part and the lower part of the inner volume of said enclosure. This separation ensures air-tightness, preventing the liquid from flowing out of the cartridge if the latter is overturned.

In another feature of the invention, the compressor and its motor are arranged in a cylindrical sheath extending vertically in the upper part of the inner volume of the enclosure and centered with respect to the latter, said sheath having a bottom wall and being closed in the upper part by a lid provided with through holes for letting in air, the holes being organized in a zigzag.

In another feature of the invention, the sheath, in combination with the enclosure, delimits the expansion chamber of the aerosol, the aerosol enters the expansion chamber by the lower part of the latter, the sheath is made of a heat-conducting material in order to effect a heat exchange with the formed aerosol, the sheath, in the upper part, has a peripheral flange for closing the upper part of the inner volume of the enclosure and of the expansion chamber, and said flange has a through hole for evacuating the aerosol.

Owing to such an arrangement, the wall of the sheath is swept by the aerosol and a thermal exchange takes place between the aerosol and said wall. The heat emitted by both the compressor and by its motor is thus communicated to the aerosol and is evacuated by the latter. Such an arrangement is favorable to the cooling of the compressor and the associated motor but also to the acceleration of the evaporation of the fine droplets of liquid, contained in the aerosol.

In another feature of the invention, the compressed air outlet included in the compressor is directly connected to the compressed air inlet of the two-way nozzle which greatly reduces pressure drops.

Such an arrangement is favorable, firstly to reducing the air pressure required for the correct operation of the two-phase nozzle and therefore to using compressors of low mechanical power which are consequently cheaper. Furthermore, the motor of the compressor can then be of low electrical power, in proportion to the power of the compressor, which will further reduce the cost of the cartridge. This electric motor can then be powered with a low voltage of around four volts. The pressure delivered by the compressor will be in the order of 50 millibars.

In another feature of the invention, the head of the compressor can a geometrical profile directly similar to the nozzle, thus making it possible to reduce the number of parts.

In another feature of the invention, the head of the compressor and its pump barrel can be an integral part of the cartridge, thus making it possible to freely affix any type of electric motor.

In another feature of the invention, the suction cannula includes at least one inner suction channel, the or each inner suction channel is equipped in the lower part with a filter and said cannula is equipped with a channel for evacuating toward the container the liquid particles collected by a partition wall, in the shape of a funnel, which ensures a separation between the upper part and the lower part, forming a container for the liquid, with the inner volume of an enclosure forming the cartridge.

In another feature of the invention, the cannula is equipped in the lower part with straining means.

In another feature of the invention, the straining means bounds firstly a first, lower inner chamber in communication with the liquid container and with a suction channel formed by a tube engaged in a casing of the cannula and secondly a second, upper inner chamber, in communication firstly with the evacuation pipe and secondly with the first chamber through an annular through hole.

In another feature of the invention, the cannula enters the casing housing the suction tube and the evacuation channel is fitted with an elongate vertical chamber sealingly closed in the upper part and open in the lower part, to be in communication with the upper chamber of the straining means.

In another feature of the invention, the means of planned obsolescence are formed by an electronic circuit connected to the motor of the compressor to control it and power it with electrical energy.

In another feature of the invention, the electronic circuit is capable of measuring and totaling up the consumption of sprayed liquid and comparing this consumption with a setpoint value representative of the quantity of liquid present in the container before the first use, and interrupting the supply of electrical energy to the compressor motor when the setpoint value has been reached.

In another feature of the invention, the electronic circuit incorporates at least:
a memory block containing a data item relating to the quantity of liquid present in the container before the first use of the apparatus, a data item relating to the nature of the liquid and a data item relating to the viscosity of the liquid to be sprayed,
a microcontroller capable of computing the instantaneous flow rate of liquid, and the quantity of liquid consumed, said microcontroller being in addition capable of comparing the consumed quantity to the setpoint value,
a power interface via which the compressor motor is supplied with electrical energy, said power interface being controlled by the microcontroller to interrupt the powering of the motor when the setpoint value has been reached.

The microcontroller is capable of communicating to the electronic controller card of the machine (motherboard of the terminal) the data present in its memory block and in particular a data item relating to the end of its allocated operating time.

This communication is done over the power supply wires according to a protocol specific to the cartridge.

Alternatively, in another feature of the invention, the electronic circuit is capable of totaling the durations of the operating cycles of the motor and comparing the value obtained to a setpoint value representative of the maximum authorized duration of operation of said motor, and interrupting the supply of electrical energy to said compressor motor when the setpoint value has been reached, and this setpoint value corresponds to the time required for complete draining of the container. The value obtained by totaling the durations of the previous operating cycles is representative of the quantity of liquid consumed.

In another feature of the invention, the electronic circuit incorporates at least:
a memory block containing a data item relating to the maximum duration of use of the compressor motor,
a microcontroller capable of measuring and totaling the durations of operating cycles of the compressor motor and comparing the value of this measurement to the setpoint value,
a power interface via which the compressor motor is supplied with electrical energy, said power interface being controlled by the microcontroller to interrupt the powering of the motor when the setpoint value has been reached.
The microcontroller dialogues with the motherboard in real time and keeps the use time of the cartridge in the memory; this is an advantage when changing the cartridge during use.
The microcontroller can also deliver information about the nature of the contents of the cartridge to the motherboard, such as for example the name of the liquid, its dates of manufacture and expiry and other data.

### BRIEF DISCLOSURE OF THE FIGURES AND DRAWINGS

Other advantages, aims and features of the invention will become apparent upon reading the description of a preferred embodiment, given by way of non-limiting example with reference to the appended drawings wherein:

FIG. 1 is a perspective view, on an enlarged scale, of a cartridge in accordance with the invention,

FIG. 2 is a top view of the cartridge according to the invention,

FIG. 3 is a section view along the line AA of FIG. 2,

FIG. 4 is an insert view showing the detail of the two-phase nozzle with which the cartridge according to the invention is equipped,

FIG. 5 is a perspective view of a partition wall and a suction cannula,

FIG. 5a is a front view of a variant embodiment of a partition wall with suction cannula,

FIG. 5b is a section view of another alternative embodiment of a cannula with partition wall,

FIGS. 5c and 5d are respectively top and bottom perspective views of the straining means,

FIG. 6 is a perspective view of a sheath,

FIG. 7 is a longitudinal section view of the sheath in FIG. 6,

FIG. 8 is a bottom perspective view of the lid associated with the sheath,

FIG. 9 is a section view of this lid,

FIG. 10 is a perspective view of the cradle in which the sheath rests,

FIG. 11 is a schematic view of the electronic circuit,

FIG. 12 is a reduced-scale view of a dispensing apparatus equipped with a cartridge according to the invention.

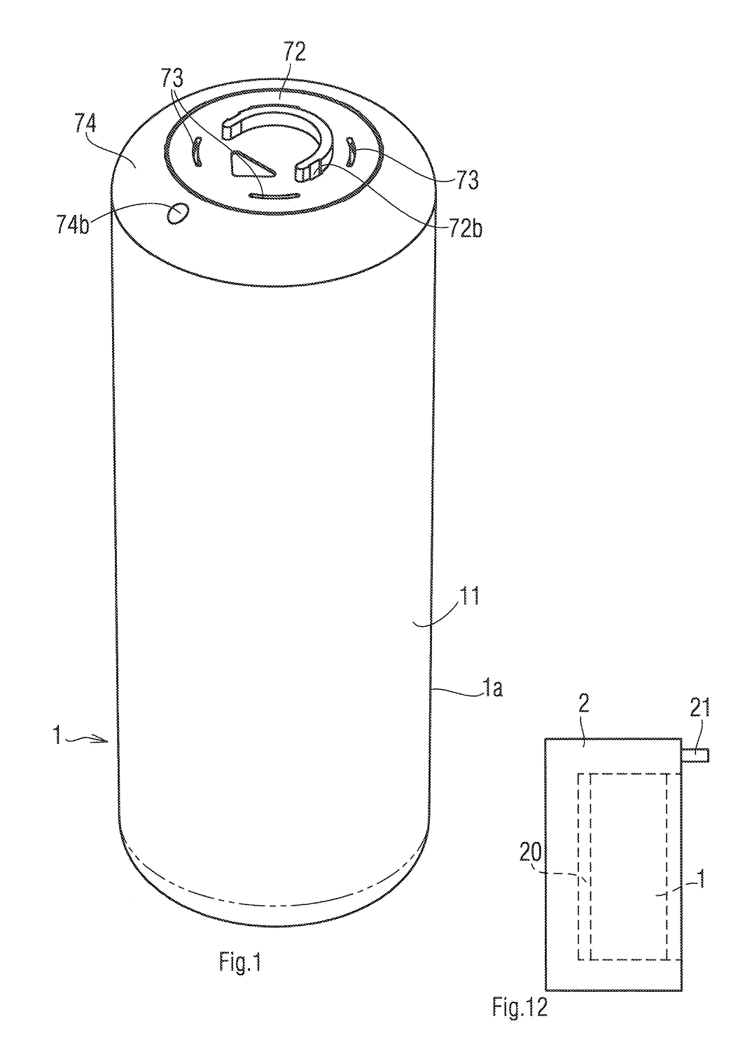

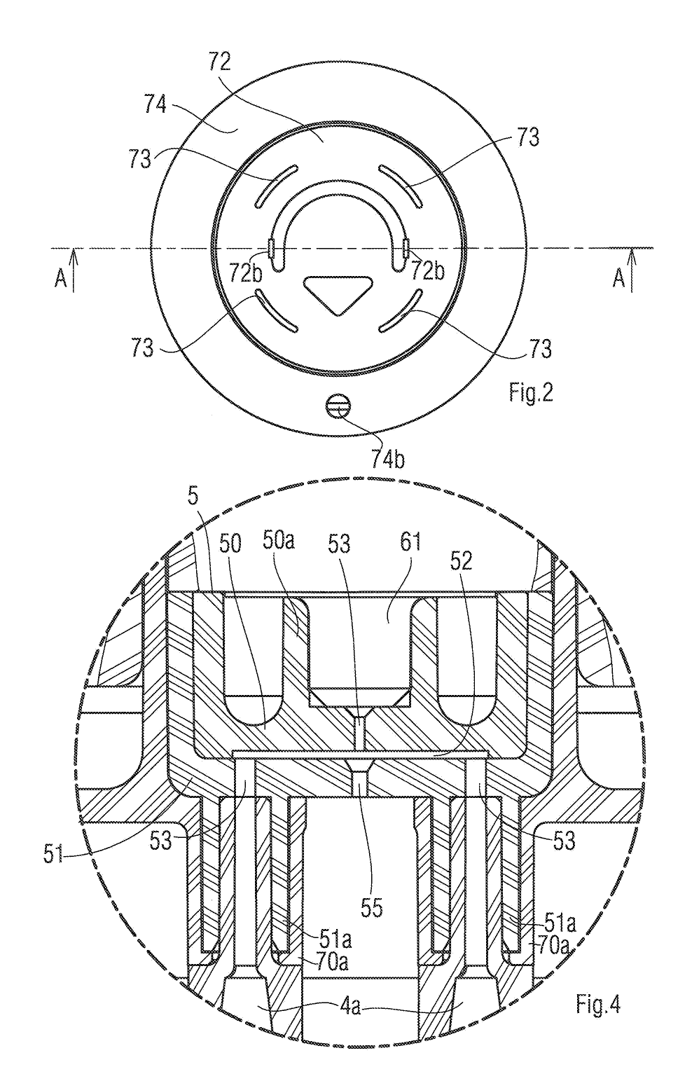

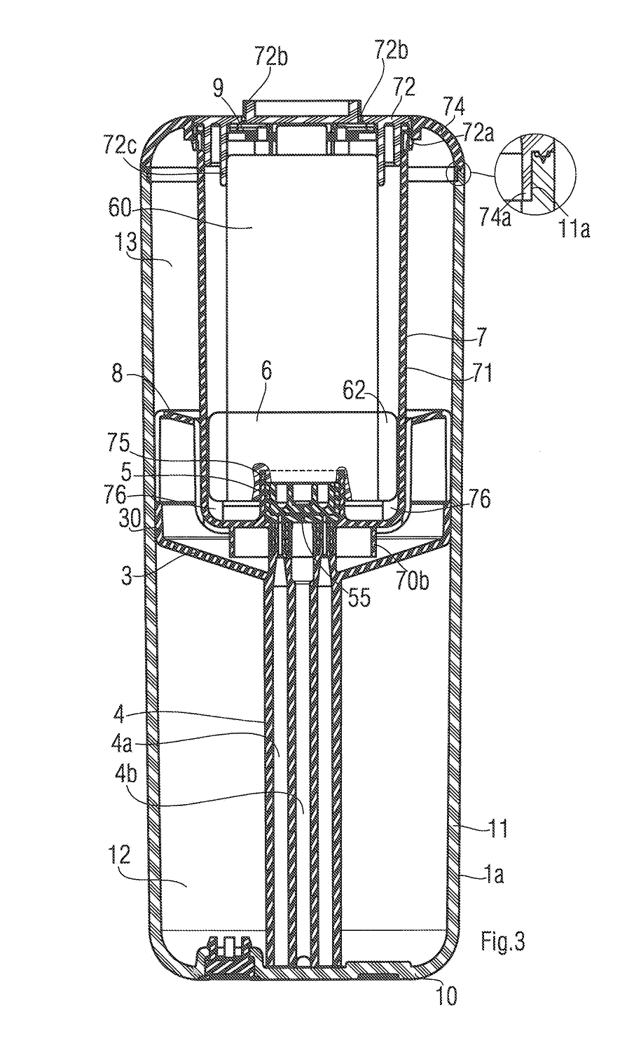

### BEST EMBODIMENT OF THE INVENTION

As represented, the cartouche 1 according to the invention, for the production and dispensing of an aerosol, is intended to be introduced into an aerosol-dispensing apparatus 2.

The cartridge 1, according to the invention, comprises a sealed enclosure 1a, of cylindrical shape, including a circular bottom 10 and a peripheral wall 11 rooted in this bottom 10.

The lower part of the inner volume of the enclosure 1a forms a container 12 intended to receive a liquid to be sprayed and is separated from the upper part of the inner volume by a partition wall 3, forming a funnel around a suction cannula 4 extending down into the container 12 and intended to feed liquid, a two-phase nozzle 5 for producing an aerosol, mounted in the upper part of the inner volume of the enclosure 1a above the partition wall 3 and supplied with compressed air by a compressor 6, motorized and also mounted with its motor 60 in the upper part of the inner volume of the enclosure 1a.

The container 12 can have various capacities. Thus, the latter, by way of non-limiting example, can have capacities of 20 ml, 200 ml, 5000 ml or above.

According to the preferred embodiment, the partition wall 3 is fitted with a cylindrical annular flange 30, oriented upward, with an outer diameter equal to the inner diameter of the enclosure 1a. By way of this annular flange 30, the separating wall 3 is rigidly affixed, by ultrasonic welding for example, to the peripheral wall 11 of the enclosure 1a.

Advantageously, the compressor 6 and its motor 60 as well as the two-phase nozzle 5 are arranged in a cylindrical sheath 7 extending vertically into the upper part of the inner volume of the enclosure 1a and centered with respect to the latter.

This sheath 7 has a bottom wall 70 and a peripheral wall 71. This sheath 7 is closed in the upper part by a lid 72 provided with through holes 73 for letting in air, organized in a zigzag to impede the introduction of foreign bodies into the sheath 7.

According to a practical embodiment, the lid 72 is equipped with projecting tabs 72a intended to be clipped into tracks 71a formed in the peripheral wall 71 of the sheath 7, in the upper part. This lid 72 has vertical tabs 72c determining a wedging casing wherein the upper part of the motor 60 of the compressor 6 is introduced. In the lower part, the sheath 7, in its inner volume, has several pairs of radial flaps 76 each determining a wedging casing intended to receive a wedging radial flap 62 carried by the compressor 6. In this way the compressor and motor assembly is perfectly positioned and held in the sheath 7.

Preferably, the sheath 7, has a peripheral flange 74 in the upper part for closing the upper part of the enclosure 1a. This flange 74 has a cylindrical annular recess 74a intended to be housed in and against a form of counterbore 11a formed at the upper end of the peripheral wall 11 and be sealingly affixed there, for example by ultrasonic welding.

The sheath 7, on the inside of its bottom wall 70, has a casing 75 wherein the two-phase nozzle 5 is mounted.

The nozzle 5 is preferably in accordance with that described in the patent application FR 2 947 191 and is formed from a nozzle body in two parts, upper 50 and lower 51, sealingly joined and together delimiting a vacuum chamber 52 wherein the liquid to be sprayed is sucked by Venturi effect. More precisely, the upper part 50 of the nozzle body is fitted with a through hole 53 for introducing compressed air, in communication with the inner volume of a nipple connector 50a of the part 50, wherein a nozzle 61 for delivering compressed air included in the compressor 6 is sealingly engaged. Alternatively, the upper part 50 is incorporated into the compressor 6 and forms a single part with the latter.

The lower part 51 of the nozzle body includes at least a first through hole 54 for taking liquid into the vacuum chamber 52, this first hole opening into a vertical nipple connector 51a included in the lower part 51 of the nozzle body. This nipple 51a is engaged in a through hole made in the bottom wall 70 of the sheath 7 and receives the suction cannula 4, which is fitted with at least one inner suction channel 4a that will be in communication with the suction holes 54 included in the lower part 51 of the nozzle body.

According to a practical embodiment, the nipple 51a is engaged in a vertical tubular form 70a, rooted in the bottom wall 70 and forming a projection under the latter.

The lower part 51 of the nozzle body, on the axis of the through hole 53 included in the upper part 50, is fitted with a through hole 55 for evacuating the aerosol, this said hole being axially aligned with a through hole made in the bottom wall 70 of the sheath 7.

Preferably, the lower part 51 of the nozzle body has two sets of suction holes 54 symmetrically arranged with respect to the holes for evacuating the aerosol, both being in communication with two nipples 51a respectively engaged in two tubular forms 70a. With such an embodiment, the suction cannula 4 includes two suction pipes 4a respectively in communication with the two holes 54 and its upper end forms a fork so that it can be connected to the two nipples 51a.

So as to reduce the sound level of the nozzle, the bottom wall 70, in projection under its face outside the sheath, can have a circular ring 70b, extending around and at a distance from the cannula 4 and the holes 55 for evacuating the aerosol. It is noteworthy that this ring enters into the funnel shape of the partition wall 3 and is situated at a short distance from the upper face of the latter. This ring makes it possible to better filter the aerosol by trapping the large particles. The inner volume formed by this funnel is preferably centered on the holes 55.

The suction cannula 4 crosses the partition wall 3 from end to end and is sealingly joined to the latter. Preferably, the cannula forms a single part with the partition wall 3.

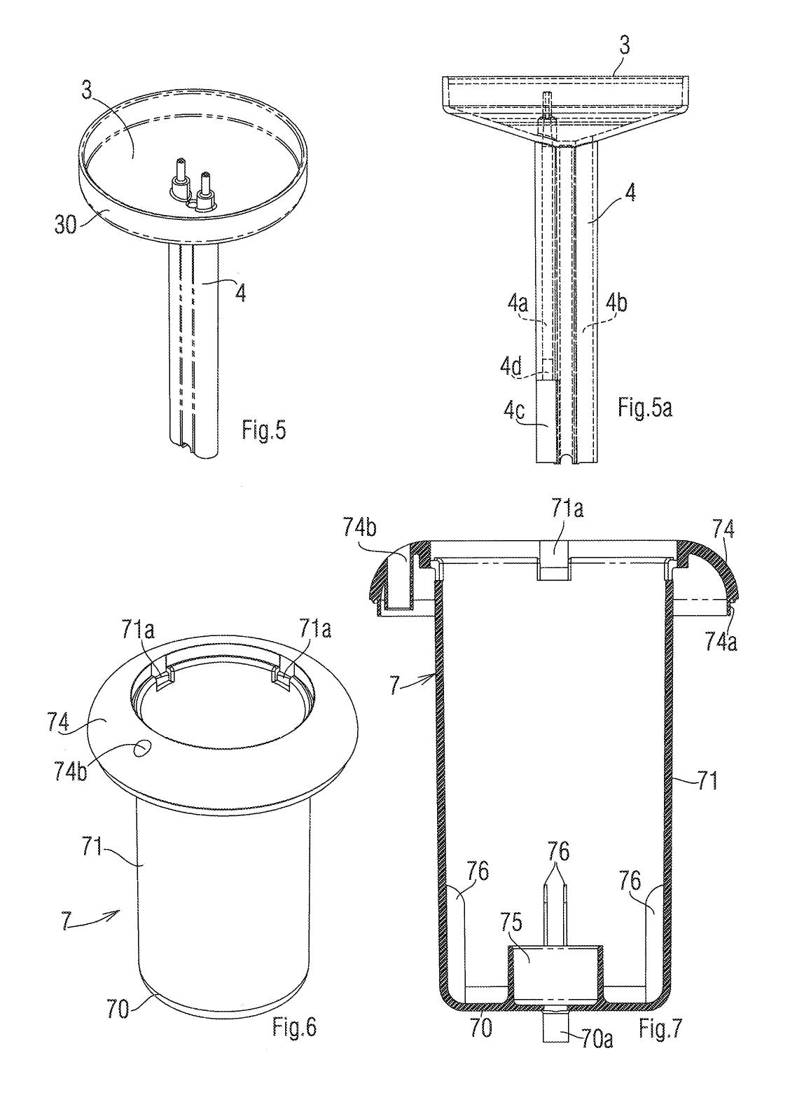

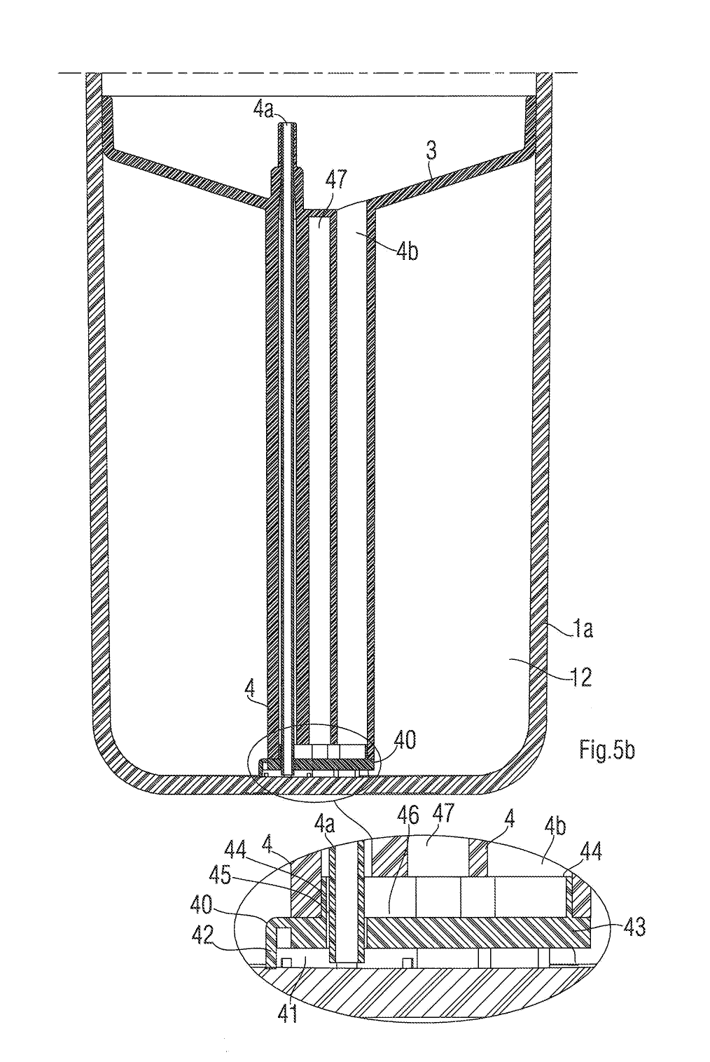

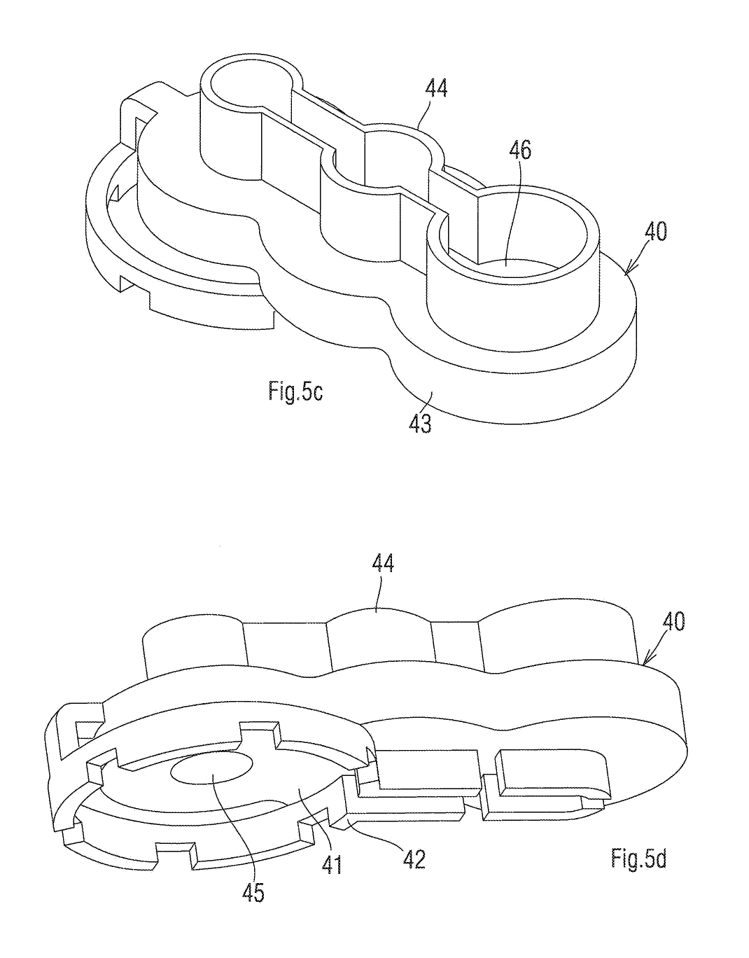

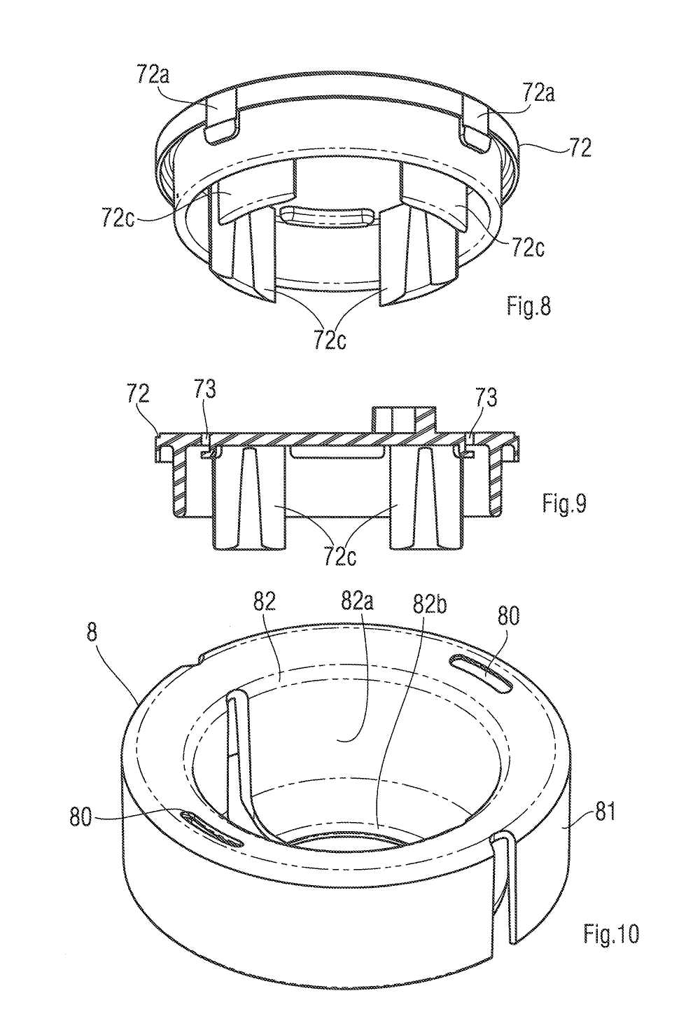

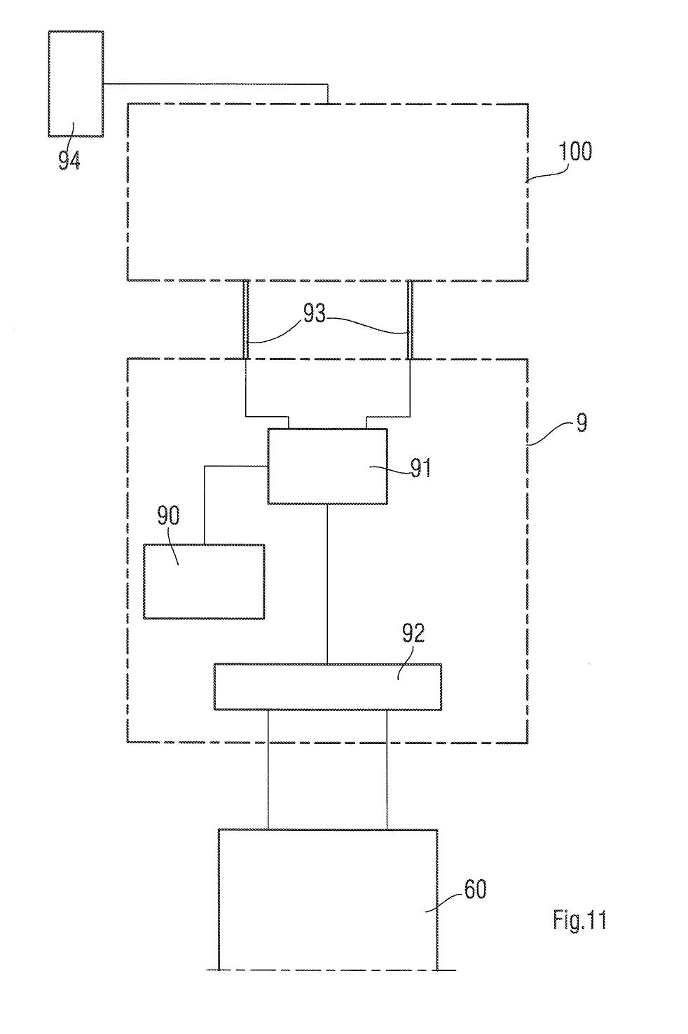

It can be observed that the cannula in FIG. 5 includes two suction channels, whereas the cannula in 5a and 5b has only one. The fact of using only a single cannula makes it possible to limit the flow rate of sucked liquid and to reduce the risk of cavitation of the nozzle. The suction channel 4a can receive in the lower part a rigid filter 4c (FIG. 5a) capable of retaining solid impurities and dirt that the liquid could contain. This filter also has the purpose of regulating the suction. This filter 4c is equipped with a connection sleeve 4d intended to be engaged in the inner channel 4a of the cannula 4.

The sheath 7 is made from a heat-conducting material. This sheath 7, by way of its lower part, is mounted in a cradle 8 carried by the separating wall 3. This cradle 8 ensures the sheath 7 is held at a distance and above the separating wall 3. Thus, the aerosol delivered by the nozzle 5 is first introduced into the region between the cradle 8 and the separating wall 3 and is then evacuated, by passing through the through holes 80 made in the cradle 8, toward the annular expansion chamber 13, formed between the upper part of the enclosure and the peripheral wall 71 of the sheath 7. This expansion chamber 13 is also delimited by the cradle 8 in the lower part and by the flange 74 in the upper part.

To allow the evacuation of the aerosol to the outside from this expansion chamber 13, the flange 74 is fitted with a through hole 74b.

Thanks to the arrangements that have just been described, the aerosol comes into contact with the outer face of the sheath 7 and the heat emitted by both the motor 60 and the compressor 6 is thus evacuated by the aerosol. Such an arrangement ensures correct cooling of the motor 60 and the compressor 6 and favors the evaporation of the droplets of liquid contained in the aerosol. The sealing of the sheath 7 prevents any contact between the aerosol and the compressor 6 and its motor 60.

Owing to the cradle 8 and the flange 74, the sheath 7 is firmly held in the enclosure 1a in a fixed manner.

The cradle 8, according to a preferred embodiment, comprises a tubular wall 81 by the lower rim of which it rests on the upper rim of the annular flange 30 of the separating wall 3. The cradle 8 furthermore comprises at least two tabs 82 for holding the sheath 7, rooted in a horizontal flap that they each have, to the upper rim of the tubular wall 81. These tabs have a regular angular separation from one another. The through holes 80 are formed in the horizontal flaps of the tabs 82. Each holding tab 82 has a vertical segment of tab 82a extended in the lower part by a horizontal segment of tab 82b for bearing the sheath 7, this segment extending radially toward the center of the formed cradle.

On leaving the nozzle 5, the aerosol is oriented vertically downward and toward the separating wall 3. The large particles of liquid that the aerosol can transport are too heavy to be transported toward the expansion chamber 13 and are deposited on the partition wall 3. To avoid any congestion at this level, the suction cannula 4, in the extension of an axial through hole formed in the wall 3, has a pipe 4b for evacuating these particles under gravity toward the container 12 of liquid. It is noteworthy that the evacuation pipe 4b and the suction pipe(s) 4a included in the cannula 4 open, by their lower end, onto the lower end of the cannula, which end is resting on or at a very short distance from the bottom of the container 12. Such an arrangement avoids the overturning of the capsule leading to the reflux of the liquid toward the upper part of the cartridge 1. The partition wall 3 also opposes this reflux in the event of the cartridge 1 being overturned.

FIG. 5b represents another embodiment of the cannula 4. This cannula 4 forms a single part with the separating wall 3, which is always funnel-shaped. This cannula includes only a single suction channel 4a formed by a tube and an evacuation channel 4b. The tube forming the suction channel 4a is introduced into a cylindrical, vertical tubular casing of the cannula 4. In the upper part, this cylindrical casing includes a narrower section to receive the upper part of the suction tube 4a without clearance. A seal can be arranged, in the upper part, between the casing included in the cannula 4 and said tube. In the lower part, an annular clearance is left between the tube and its casing.

The lower parts of the tube and the cannula 4 are preferably engaged in a straining means 40 affixed to the bottom wall of the container 12. This straining means 40 bounds at least a first, lower inner chamber 41 in communication with the inner volume of the container 12. This chamber is delimited by a peripheral wall 42 and by a horizontal upper wall 43 rooted in the peripheral wall 42. This straining means 40 rests on the bottom of the container 12 by the lower rim of the peripheral wall 42. The lower inner chamber 41 is in communication with the inner volume of the container 12 by through holes particularly made in the peripheral wall 42.

The upper wall 43 of the straining means 40 includes at least one vertical nipple connector 44, extending a through hole 45 made in the upper wall 43 and opening into the first lower inner chamber 41. The nipple connector 44 is intended to receive the lower part of the cannula 4 by fitting. The suction tube is engaged in the nipple 44 and in this set of through holes 45 and is housed in the lower chamber 41 by its lower part. The lower part of the suction tube 4a is arranged at a short distance from the bottom of the container 12. Advantageously, the lower chamber 41 is equipped with a filter, not represented. This filter is capable of retaining the solid impurities and dirt that the liquid to be dispensed could contain. This filter also has the purpose of regulating the suction.

The nipple connector 44, in combination with the upper wall 43, bounds a second, upper inner chamber 46. This upper chamber is in communication firstly with the evacuation channel 4b of the cannula and secondly with the lower chamber 41 through an annular space left between the hole 45 and the suction tube 4a. In this way, the flows collected in the upper part by the funnel formed by the separating wall 3 can flow toward the first chamber 41 and be absorbed into the stream of sucked liquid. Additionally, the small width of this annular space limits upflows of liquid toward the funnel 3 when the cartridge is set on its side due to carelessness. Advantageously between the evacuation pipe 4b and the casing provided to house the suction tube 4a, the cannula includes a long vertical chamber 47 sealingly closed in the upper part and open in the lower part to be in communication with the upper chamber 46. Such a chamber 47 is capable of collecting upflows of liquid when the cartridge is set on its side. This chamber is capable of limiting upflows of liquid toward the funnel formed by the wall 3 and consequently upflows of liquid toward the upper part of the cartridge. Advantageously, the evacuation pipe 4b is offset laterally with respect to the center of the funnel formed by the partition wall 3.

The cartridge 1 as described is fitted with an electronic circuit 9 capable of powering and controlling the motor 60 of the compressor 6.

According to a first embodiment, the electronic circuit 9 is capable of measuring and totaling the consumption of sprayed liquid and comparing this consumption to a setpoint value representative of the quantity of liquid present in the container 12 before the first use, and interrupting the supply of electrical energy to the motor 60 of the compressor 6 when the setpoint value has been reached.

According to this embodiment, the electronic circuit 9 incorporates at least:
a memory block 90 containing a data item relating to the quantity of liquid present in the container before the first use of the apparatus, a data item relating to the nature of the liquid and a data item relating to the viscosity of the liquid to be sprayed,
a microcontroller 91 capable of computing the instantaneous flow rate of consumption of liquid, and the quantity of liquid consumed, said microcontroller being also capable of comparing the quantity consumed to the setpoint value,
a power interface 92 via which the motor 60 of the compressor is supplied with electrical energy, said power interface 92 being controlled by the microcontroller 91 to interrupt the powering of the motor 60 when the setpoint value has been reached.

According to a second embodiment, the electronic circuit 9 is capable of measuring and totaling the durations of the operating cycles of the motor 60 and comparing the value obtained to a setpoint value representative of the maximum authorized duration of operation of said motor, and interrupting the supply of electrical energy to said compressor motor 60 when the setpoint value has been reached, this setpoint value corresponding to the time required for complete draining of the container 12.

According to this second embodiment of the invention, the electronic circuit incorporates at least:
a memory block 90 containing a data item relating to the maximum duration of use of the compressor motor,
a microcontroller 91 capable of measuring and totaling the durations of the operating cycles of the compressor motor and comparing the value of this measurement to the setpoint value,
a power interface 92 via which the compressor motor is supplied with electrical energy, said power interface being controlled by the microcontroller to interrupt the powering of the motor when the setpoint value has been reached.

In the practical embodiment, the electronic circuit 9 is mounted entirely or partly in the sheath 7 between the motor 60 of the compressor 6 and the lid 72. This lid 72 has through holes 72b for running electrical pins 93 for supplying electrical energy to both the electronic circuit and the motor 60. These electrical pins 93 are connected to a source of electrical energy 94 outside the cartridge.

The cartridge 1, as described, can be used as such or else be arranged in an apparatus 2 for dispensing an aerosol. This apparatus 2 is preferably in the form of a box fitted with an inner chamber 20 wherein the cartridge 1 according to the invention is removably arranged.

This apparatus 2 is fitted with a fitting 21 for delivering the aerosol, facing which is positioned the hole 74b included in the cartridge 1. This box 2 is equipped with pins 93 and with the electrical energy source 94, the latter appearing in the form of low-voltage accumulators of electrical energy. Alternatively, the pins 93 are carried by the cartridge and are intended to be connected to electrical contacts carried by the apparatus 2.

This apparatus 2 is also equipped with an electronic circuit 100 through which the electrical energy source 94 powers the pins 93. The circuit 9 and the electronic circuit 100 are capable of exchanging data by way of the pins 93.

The exchanged data can relate to an identifier specific to the cartridge 1 and entered in the memory block 90 of the circuit 9 and to the time of use of the cartridge. This data will be entered into a memory block of the circuit 100. These arrangements will make it possible to manage the changing of the cartridge before the liquid has been drained by preserving the time of use of each cartridge in a memory block of the circuit 100 of the apparatus 2.

The identifier of the cartridge will allow the apparatus to determine whether or not the latter is compliant and whether or not it can be used. If such is not the case, the supply of electrical energy to the motor 60 will be prevented by the circuit 100.

The memory block 90 can also contain data relating to the nature of the cartridge contents, such as for example the nature of the liquid, its manufacturing and expiry dates as well as other data.

These various items of data will be communicated to the circuit 100 and entered in a memory block of the latter.

Owing to these various arrangements, a same apparatus 2 can manage several cartridges 1, which can be used in alternation according as desired by the user until the liquid they contain has been drained.

It is obvious that the present invention can receive any arrangement and variant in the field of technical equivalents without departing from the scope of the present patent as defined by the claims hereinafter.

1. A cartridge for producing and dispensing an aerosol (1) comprising a container (12) containing a liquid to be sprayed, a two-phase spraying nozzle (5) in communication with the container (12) by an inner channel (4a) of a suction cannula (4) and an air compressor (6) capable of producing a carrier stream of compressed air introduced into the two-phase nozzle (5) so that the contents of the container is first sucked in by Venturi effect, then fractionated and finally propelled first to an expansion chamber (13) and then to the outside, still by the carrier stream, characterized in that the elements of which it consists form a non-dismountable assembly and that it includes means of planned obsolescence capable of directly or indirectly determining the total quantity of liquid consumed in previous operating cycles, capable of comparing this value with a setpoint value representative of the quantity of liquid present in the container before the first use, and capable of preventing the subsequent operation of the compressor when the liquid contained in the container (12) has been drained.

2. The cartridge according to claim 1, characterized in that the air compressor (6) is equipped with an electrical actuator motor (60) and in that said compressor with its motor are arranged in said cartridge.

3. The cartridge according to claim 1, characterized in that it is formed from an enclosure (1a) whereof the lower part of its inner volume forms a liquid container (12) and whereof the upper part of its inner volume receives the air compressor (6) and its motor (60) as well as the two-phase spraying nozzle (5), said enclosure (1a) receiving a partition wall (3) in the shape of a funnel which ensures a separation between the upper part and the lower part of the inner volume of said enclosure (1a).

4. The cartridge according to claim 3, characterized in that the compressor (6) and its motor (60) are arranged in a cylindrical sheath (7) extending vertically in the upper part of the inner volume of the enclosure (1a) and centered with respect to the latter, said sheath (7) having a bottom wall (70) and being closed in the upper part by a lid (72) provided with through holes (73) for letting in air, organized in a zigzag.

5. The cartridge according to claim 4, characterized in that the sheath (7) in combination with the enclosure (1a) delimits the expansion chamber (13) of the aerosol, in that the aerosol enters the expansion chamber (13) by the lower part of the latter, in that the sheath (7) is made of a heat-conducting material in order to effect a heat exchange with the formed aerosol, in that the sheath (7), in the upper part, has a peripheral flange (74) for closing the upper part of the inner volume of the enclosure (1a) and of the expansion chamber (13), and in that said flange (74) has a through hole (74b) for evacuating the aerosol.

6. The cartridge according to claim 4, characterized in that the sheath (7) is mounted by its lower part in a cradle (8) carried by the separating wall (3), said cradle being equipped with a through hole (80) for the passage of the aerosol toward the expansion chamber (13).

7. The cartridge according to claim 4, characterized in that the sheath, (7) on the inside of its bottom wall (70), has a casing (70a) wherein the two-phase nozzle (5) is mounted, in that bottom wall (70) of the sheath (7) is fitted with a through hole axially aligned with the through hole (55) for evacuating the aerosol from the two-phase nozzle (5), and in that the nozzle (5) is fitted with holes for letting in compressed air (53) in communication with the compressed air outlet of the compressor (6) and at least one hole (54) for sucking liquid, in communication by way of the inner suction channel (4a) with the suction cannula (4), with the liquid container (12).

8. The cartridge according to claim 7, characterized in that the bottom wall (70), in projection under its face outside the sheath (7), has a circular ring (70b), extending around and at a distance from the cannula (4) and from the holes (55) for evacuating the aerosol and that this ring enters into the funnel shape of the partition wall (3).

9. The cartridge according to claim 7, characterized in that on leaving the nozzle (5), the aerosol is oriented toward the partition wall (3).

10. The cartridge according to claim 7, characterized in that the cannula (4) is sealingly affixed to the partition wall (3).

11. The cartridge according to claim 9, characterized in that the cannula (4) in the extension of a through hole formed in the wall (3) has a pipe (4b) for evacuating toward the container (12) liquid particles deposited on the partition wall (3).

12. The cartridge according to claim 1, characterized in that the compressed air outlet included in the compressor (6) is directly connected to the compressed air inlet of the two-way nozzle (5).

13. The cartridge according to claim 1, characterized in that the two-phase nozzle (5) is formed from a nozzle body in two upper (50) and lower (51) parts, sealingly joined together and together delimiting a vacuum chamber (52) wherein the liquid to be sprayed is sucked by Venturi effect, the upper part being incorporated into the compressor (6).

14. The cartridge according to claim 1, characterized in that the suction cannula (4) includes at least one inner suction channel (4a), the or each inner suction channel being equipped in the lower part with a filter and in that said cannula is equipped with a channel (4b) for evacuating toward the container (12) the liquid particles collected by a partition wall, in the shape of a funnel, which ensures a separation between the upper part and the lower part, forming a liquid container, of the inner volume of an enclosure (1a) forming said cartridge.

15. The cartridge according to claim 1, characterized in that the cannula (4) is equipped in the lower part with straining means (40).

16. The cartridge according to claim 14, characterized in that the cannula (4) is equipped in the lower part with straining means (40), and the straining means bound firstly a first, lower inner chamber (41) in communication with the liquid container (12) and with a suction channel (4a) formed by a tube engaged in a casing of the cannula (4) and secondly a second upper inner chamber (46), in communication firstly with the evacuation pipe (4b) and secondly with the first chamber (41) through an annular through hole (45).

17. The cartridge according to claim 16, characterized in that the cannula (4) between the casing housing the suction tube (4a) and the evacuation pipe (4b) is fitted with an elongate vertical chamber (47) sealingly closed in the upper part and open in the lower part to be in communication with the upper chamber (46).

18. The cartridge according to claim 2, characterized in that the planned obsolescence means are formed by an electronic circuit (9) connected to the motor (60) of the compressor to control it and supply it with electrical energy.

19. The cartridge according to claim 18, characterized in that the electronic circuit (9) is mounted in the sheath (7) between the motor (60) of the compressor (6) and the lid (72), that this lid (72) has through holes (72b) for running electrical pins (93) for supplying electrical energy to both the electronic circuit (9) and the motor (60) and that these electrical pins (93) are connected to a source of electrical energy (94) outside said cartridge.

20. The cartridge according to claim 18, characterized in that the electronic circuit (9) is capable of measuring and totaling up the consumption of sprayed liquid and comparing this consumption with a setpoint value representative of the quantity of liquid present in the container (12) before the first use, and interrupting the supply of electrical energy to the motor (60) of the compressor (6) when the setpoint value has been reached.

21. The cartridge according to claim 20, characterized in that the electronic circuit (9) incorporates at least:
a memory block (90) containing a data item relating to the quantity of liquid present in the container before the first use of the apparatus, a data item relating to the nature of the liquid and a data item relating to the viscosity of the liquid to be sprayed,
a microcontroller (91) capable of computing the instantaneous flow rate of liquid, and the quantity of liquid consumed, said microcontroller being in addition capable of comparing the consumed quantity to the setpoint value,
a power interface (92) via which the motor (60) of the compressor is supplied with electrical energy, said power interface (92) being controlled by the microcontroller (91) to interrupt the powering of the motor (60) when the setpoint value has been reached.

22. The cartridge according to claim 18, characterized in that the electronic circuit (9) is capable of measuring and totaling the durations of the operating cycles of the motor (60) and comparing the value obtained to a setpoint value representative of the maximum authorized duration of operation of said motor, and interrupting the supply of electrical energy to said motor (60) when the setpoint value has been reached, this setpoint value corresponding to the time required for complete draining of the container (12).

23. The cartridge according to claim 22, characterized in that the electronic circuit (9) incorporates at least:
a memory block (90) containing a data item relating to the maximum duration of use of the compressor motor,
a microcontroller (91) capable of measuring and totaling the durations of the operating cycles of the compressor motor and comparing the value of this measurement to the setpoint value,
a power interface (92), via which the compressor motor is supplied with electrical energy, said power interface being controlled by the microcontroller to interrupt the powering of the motor when the setpoint value has been reached.

24. An apparatus for dispensing an aerosol, characterized in that it receives a cartridge according to claim 5.

25. The apparatus according to claim 24, wherein the planned obsolescence means are formed by an electronic circuit (9) connected to the motor (60) of the compressor to control it and supply it with electrical energy, the electronic circuit (9) is mounted in the sheath (7) between the motor (60) of the compressor (6) and the lid (72), said lid (72) having through holes (72b) for running electrical pins (93) for supplying electrical energy to both the electronic circuit (9) and the motor (60) and said electrical pins (93) being connected to a source of electrical energy (94) outside said cartridge, said apparatus being fitted with a fitting (21) for delivering aerosol facing which is positioned the hole (74b) included in the cartridge (1), and being equipped with pins (93) and the electrical energy source (94).
